(19) United States
(12) Patent Application Publication
(10) Pub. No.: US 2004/0101629 A1
(43) Pub. Date: May 27, 2004

(54) Colour-and/or effect-producing multicoat lacquer, method for production and use thereof

(76) Inventors: Hubert Baumgart, Munster (DE); Uwe Meisenburg, Duisburg (DE); Uwe Conring, Dulmen (DE); Karl-Heinz Joost, Drensteinfurt (DE)

Correspondence Address: BASF CORPORATION, ANNE GERRY SABOURIN, 26701 TELEGRAPH ROAD, SOUTHFIELD, MI, 48034-2442, US

(21) Appl. No.: 10/398,894

(22) PCT Filed: Nov. 8, 2001
(86) PCT No.: PCT/EP01/12926

(30) Foreign Application Priority Data
Nov. 9, 2000 (EP) 100 55 549.7

(51) Int. Cl. B05D 1/36; B05D 3/02

(52) U.S. Cl. 427/407.1; 427/385.5; 427/551

(57) ABSTRACT

A multicoat system produced by

1. applying a surfacer to a substrate and drying the resultant wet film without completely curing it, to give a surfacer film, or curing the resultant wet film thermally and optionally with actinic radiation, to give a surfacer coat,

2. applying a basecoat material to the surfacer film/surfacer coat, and drying the resultant wet film without completely curing it, to give a basecoat film, or curing the resultant wet film alone or together with the surfacer film thermally and, optionally, with actinic radiation, to give a color and/or effect basecoat,

3. applying a multicomponent clearcoat material to the basecoat film/basecoat, and curing the resultant wet film alone, together with the basecoat film or together with the basecoat film and the surfacer film, with actinic radiation and thermally, to give the multicoat system;

wherein, the thermal curing is carried out at temperatures <120° C.

The present invention relates to a novel multicoat color and/or effect coating system. The present invention additionally relates to a novel process for producing multicoat color and/or effect coating systems. The present invention further relates to the use of the novel multicoat color and/or effect coating system for automotive OEM finishing, automotive refinish, the coating of furniture, doors, windows or the interior and exterior of constructions, and for industrial coating, including coil coating, container coating and the coating or impregnation of electrical components.

Color or color and effect coating systems of motor vehicle bodies, especially automobile bodies, nowadays consist preferably of a plurality of coats which are applied atop one another and have different properties.

For example, an electrodeposition coat (electrocoat) as primer, a surfacer coat or antistonechip primer, a basecoat, and a clearcoat are applied in succession to a substrate. In this system, the electrocoat serves in particular to protect the sheet metal against corrosion. In the art it is often also referred to as the primer. The surfacer coat serves to mask unevennesses in the substrate and because of its elasticity imparts stone-chip resistance. If appropriate, the surfacer coat may also serve to reinforce the hiding power and to deepen the shade of the coating system. The basecoat contributes the colors and/or the optical effects. The clearcoat is used to intensify the optical effects and to protect the coating system against mechanical and chemical damage. Basecoat and clearcoat are often also referred to collectively as topcoat. For further details, reference is made to Rbmpp Lexikon Lacke und Druckfarben, Georg Thieme Verlag, Stuttgart, New York, 1998, pages 49 and 51, “Automotive coating materials”.

In automotive OEM (i.e., production line) finishing, particularly stringent requirements are imposed on the quality of the multicoat color and/or effect coating system. Critical to the appearance of an automotive OEM finish of high quality are optical properties such as

high gloss,

high distinctness of image (DOI),

high hiding power,

no difference in shade at different locations, and

precise dichroic optical effects,

mechanical properties such as

high hardness,

high scratch resistance,

high abrasion resistance, and

high impact resistance,

adhesion properties such as

very good intercoat adhesion, and

very good adhesion to the substrate,

and also chemical properties such as

very good weathering stability,

very good UV resistance,

very good resistance to blushing,

very good etch resistance, and

very good resistance to chemicals (especially acids and bases), solvent, tree resin, bird droppings, and gasoline

(cf. also the European patent EP 0 352 298 B1).

The known multicoat color and/or effect coating systems are produced by applying a surfacer film to a primed or unprimed substrate and baking it at temperatures from 130 to 180° C. (cf. the patent applications DE 40 05 961 A1, WO 95/12626 or EP 0 788 523). A basecoat film is applied to the resultant surfacer coat and is dried without being cured. The dried basecoat film is overcoated with a clearcoat film, after which the two films are cured together (wet-on-wet technique). Normally, temperatures of 130 to 180° C. are employed in this case too (cf., for example, the European patents EP 0 730 517 B1 or EP 0 730 613 B1).

Although this process affords outstanding multicoat color and/or effect coating systems, it has the disadvantage, owing to the high temperatures employed, of being energy intensive and hence comparatively expensive.

The German patent applications DE 198 45 740 A1 or DE 198 46 971 A1 disclose two-component clearcoat materials which may also be used as two-component surfacers. These two-component systems may be cured at relatively low temperatures. They are used primarily, however, to coat plastics. It is unknown whether they may be used as part of high-quality automotive OEM finishes.

The German patent application DE 199 04 170 A1 discloses aqueous basecoat materials for coating plastics. The aqueous basecoat materials may be cured at low temperatures. Here again, it is unknown whether they may be used to produce high-quality automotive OEM finishes.

In automotive refinish as well it is known to overcoat basecoats with multicomponent clearcoats and to cure the coating materials together at comparatively low temperatures (cf. the European patent EP 0 730 613 B1). If, however, the desire is to obtain multicoat systems in automotive OEM quality, it is nevertheless necessary again to use temperatures above 130° C.

The same applies to the multicomponent clearcoat materials known from the German patent application DE 198 55 146 A1, which are curable thermally and with actinic radiation. Although, viewed per se, these coating materials may be cured at low temperatures, in the context of producing multicoat systems they are nevertheless cured thermally together ith the basecoat film at a temperature of 140° C. in rder to obtain a multicoat system in automotive OEM uality.

It is an object of the present invention to provide new multicoat color and/or effect coating systems in automotive OEM quality whose production requires less energy but which have the same advantageous profile of properties as the known multicoat color and/or effect coating systems, if not exceeding said profile. A further object of the present invention was to provide a new process for producing multicoat color and/or effect coating systems which uses less energy than the processes known to date while nevertheless requiring no significant changes to existing production-line coating units.

Accordingly, we have found the novel multicoat color and/or effect coating system with the quality of an automotive OEM coating system, which is producible by

1. applying at least one surfacer curable thermally at a temperature <120° C. or curable with actinic radiation and thermally at a temperature <120° C. to a primed or unprimed substrate and

1.1 drying the resultant wet film without completely curing it, to give a surfacer film, or

1.2 curing the resultant wet film thermally at a temperature <120° C. or with actinic radiation and thermally at a temperature <120° C., to give a surfacer coat,

2. applying at least one basecoat material curable thermally at a temperature <120° C. or curable with actinic radiation and thermally at a temperature <120° C. to the surfacer film (1.1) or the surfacer coat (1.2), and

2.1 drying the resultant wet film without completely curing it, to give a basecoat film, or

2.2 curing the resultant wet film alone or together with the surfacer film (1.1) thermally at a temperature <120° C. or with actinic radiation and thermally at a temperature <120° C., to give a color and/or effect basecoat,

3. applying at least one multicomponent clearcoat material curable with actinic radiation and thermally at a temperature of <120° C. to the basecoat film (2.1) or the basecoat (2.2), and curing the resultant wet film

3.1 alone,

3.2 together with the basecoat film (2.1) or

3.3 together with the basecoat film (2.1) and the surfacer film (1.1)

with actinic radiation and thermally at a temperature <120° C., to give the multicoat system.

In the text below, the novel multicoat color and/or effect coating system with the quality of an automotive OEM coating system is referred to as the “coating system of the invention”.

We have also found the novel process for producing a multicoat color and/or effect coating system with the quality of an automotive OEM coating system by application of at least one surfacer coat, at least one basecoat and at least one clearcoat to a primed or unprimed substrate and curing of the resultant wet films, which comprises

1. applying at least one surfacer curable thermally at a temperature <120° C. or curable with actinic radiation and thermally at a temperature <120° C. to a primed or unprimed substrate and

1.1 drying the resultant wet film without completely curing it, to give a surfacer film, or

1.2 curing the resultant wet film thermally at a temperature <120° C. or with actinic radiation and thermally at a temperature <120° C., to give a surfacer coat,

2. applying at least one basecoat material curable thermally at a temperature <120° C. or curable with actinic radiation and thermally at a temperature <120° C. to the surfacer film (1.1) or the surfacer coat (1.2), and

2.1 drying the resultant wet film without completely curing it, to give a basecoat film, or

2.2 curing the resultant wet film alone or together with the surfacer film (1.1) thermally at a temperature <120° C. or with actinic radiation and thermally at a temperature <120° C., to give a color and/or effect basecoat,

3. applying at least one multicomponent clearcoat material curable with actinic radiation and thermally at a temperature of <120° C. to the basecoat film (2.1) or the basecoat (2.2), and curing the resultant wet film

3.1 alone,

3.2 together with the basecoat film (2.1) or

3.3 together with the basecoat film (2.1) and the surfacer film (1.1)

with actinic radiation and thermally at a temperature <120° C., to give the clearcoat, the clearcoat and the basecoat, or the clearcoat, the basecoat and the surfacer coat.

In the text below, the novel process for producing a multicoat color and/or effect coating system with the quality of an automotive OEM coating system by application of at least one surfacer coat, at least one basecoat and at least one clearcoat to a primed or unprimed substrate and curing of the resultant wet films is referred to as the “process of the invention”.

Further subject matter of the invention will emerge from the description.

The process of the invention and the multicoat systems of the invention are used to coat primed or unprimed substrates.

Suitable substrates for coating are all surfaces which are undamaged by curing of the films present thereon under the combined application of heat and actinic radiation (dual cure).

Appropriate substrates comprise metals, plastics, wood, ceramic, stone, textile, fiber composites, leather, glass, glass fibers, glass wool, rock wool, mineral-bound and resin-bound building materials, such as plasterboard, cement slabs or roof tiles, and also assemblies of these materials.

Accordingly, the multicoat systems of the invention and the process of the invention are also suitable in principle for applications outside of automotive OEM finishing. In this context they may be used in particular for automotive refinish, for the coating of furniture, windows and doors, of the interior and exterior of constructions, and for industrial coating, including coil coating, container coating, and the impregnation or coating of electrical components. In the context of industrial coating, they are suitable for coating virtually all parts for private or industrial use, such as radiators, domestic appliances, small metal parts such as nuts and bolts, hubcaps, wheel rims, packaging, or electrical components such as motor windings or transformer windings.

In the case of electrically conductive substrates it is possible to use primers, which are produced in conventional manner from electrodeposition coating materials. Both anodic and cathodic electrodeposition coating materials are suitable for this purpose, but especially cathodics.

It is also possible to coat primed or unprimed plastics parts made, for example, from ABS, AMMA, ASA, CA, CAB, EP, UF, CF, MF, MPF, PF, PAN, PA, PE, HDPE, LDPE, LLDPE, UHMWPE, PC, PC/PBT, PC/PA, PET, PMMA, PP, PS, SB, PUR, PVC, RF, SAN, PBT, PPE, POM, PUR-RIM, SMC, BMC, PP-EPDM and UP (abbreviations in accordance with DIN 7728T1). Unfunctionalized and/or nonpolar substrate surfaces may be subjected to a conventional pretreatment prior to coating, such as with a plasma or by flaming, or may be provided with a primer.

In the context of the process of the invention, the coating materials may be applied by any customary application method, such as spraying, knife coating, brushing, flow coating, dipping, impregnating, trickling or rolling, for example. The substrate to be coated may itself be at rest, with the application equipment or unit being moved. Alternatively, the substrate to be coated, especially a coil, may be moved, with the application unit being at rest relative to the substrate or being moved appropriately.

Preference is given to the use of spray application methods, such as compressed air spraying, airless spraying, high-speed rotation, electrostatic spray application (ESTA), possibly in conjunction with hot spray application such as hot air spraying, for example. Application may take place at temperatures of max. 70 to 80° C., so that appropriate application viscosities are obtained without the brief thermal exposure being accompanied by any alteration in or damage to the coating material or its overspray, which may be intended for reprocessing. For instance, hot spraying may be configured such that the coating material is heated only very briefly in the spray nozzle or shortly before the spray nozzle.

The spray booth used for the application may be operated, for example, with an optionally temperaturecontrollable circulation system, which is operated with an appropriate absorption medium for the overspray, an example of such medium being the same coating material that is being applied in each case.

If the coating material being applied in each case is curable thermally and with actinic radiation, the application is preferably conducted under illumination with visible light with a wavelength of more than 550 nm, or in the absence of light. This prevents material alteration of or damage to the dual-cure coating material and the overspray.

In general, the surfacer film, basecoat film and clearcoat film are applied in a wet film thickness such that full curing thereof results in coats having the thicknesses which are advantageous and necessary for their functions. In the case of the surfacer coat, this thickness is from 10 to 150, preferably from 15 to 120, with particular preference from 20 to 100, and in particular from 25 to 90 μm; in the case of the basecoat it is from 5 to 50, preferably from 6 to 40, with particular preference from 7 to 30, and in particular from 8 to 25 μm; and in the case of the clearcoats it is from 10 to 100, preferably from 15 to 80, with particular preference from 20 to 70, and in particular from 25 to 60 μm.

Full curing may take place after a certain rest period. This period may have a duration of 30 s to 2 h, preferably 1 min to 1 h, and in particular 1 min to 30 min. The rest period is used, for example, for leveling and devolatilization of the applied films or for the evaporation of volatile constituents such as solvents or water. The rest period may be assisted and/or shortened by the application of elevated temperatures of up to 80° C., provided this does not entail any damage to or alteration of the applied films, such as premature complete crosslinking.

The thermal curing has no special features in terms of its method but instead takes place in accordance with the conventional methods, such as heating in a forced air oven or irradiation with IR lamps. Curing may also be carried out in stages. In accordance with the invention it takes place at temperatures <120° C., preferably <110° C., and in particular <100° C., preferably for a period from 1 min up to 2 h, with particular preference 2 min up to 1 h, and in particular 3 min to 30 min.

The curing with actinic radiation also has no special features in terms of its method but instead takes place with the aid of electromagnetic radiation such as near infrared, visible light, UV radiation or X-rays, especially UV radiation, and/or corpuscular radiation such as electron beams. UV radiation is employed with preference.

In the case of electron beams, it is preferred to operate under an inert gas atmosphere. This may be ensured, for example, by supplying carbon dioxide and/or nitrogen directly to the surface of the applied films. In the case of curing with UV radiation as well, it is possible to operate under inert gas in order to prevent the formation of ozone.

Curing with actinic radiation is carried out using the conventional radiation sources and optical auxiliary measures. Examples of suitable radiation sources are high or low pressure mercury vapor lamps, with or without lead doping in order to open up a radiation window up to 405 nm, or electron beam sources. Further examples of suitable radiation sources are described in the German patent application DE 198 18 735 A1, column 10 lines 31 to 61. Their arrangement is known in principle and may be adapted to the circumstances of the workpiece and the process parameters. In the case of workpieces of complex shape, such as automobile bodies, those regions not accessible to direct radiation (shadow regions), such as cavities, folds and other structural undercuts, may be cured using point, small-area or all-round emitters in conjunction with an automatic movement apparatus for the irradiation of cavities or edges.

The equipment and conditions for these curing methods are described, for example, in R. Holmes, U.V. and E.B. Curing Formulations for Printing Inks, Coatings and Paints, SITA Technology, Academic Press, London, United Kingdom, 1984.

Curing here may take place in stages, i.e., by multiple exposure to light or actinic radiation. It may also take place in alternation, i.e., by curing alternately with UV radiation and electron beams, for example.

Thermal curing and curing with actinic radiation may be employed simultaneously or in alternation. Where the two curing methods are used in alternation, it is possible, for example, to commence with actinic radiation curing and end with thermal curing. In other cases it may prove advantageous to begin with actinic radiation curing and to end with it. The skilled worker is able to determine the curing method best suited to the individual case in hand on the basis of his or her general knowledge in the art, possibly with the assistance of simple preliminary tests.

For the production of the multicoat systems of the invention by the process of the invention, suitable coating materials include in principle all surfacers, basecoat materials and clearcoat materials in the form of powder slurries, 100% systems or aqueous or conventional liquid coating materials, especially in the form of aqueous or conventional liquid coating materials, provided they may be applied and cured as described above.

The surfacers and basecoat materials suitable for the process of the invention comprise conventional fillers, soluble dyes and/or pigments which impart color and/or effect, provide electrical conductivity or provide magnetic shielding.

Examples of suitable effect pigments are metal flake pigments such as commercial aluminum bronzes, aluminum bronzes chromated in accordance with DE 36 36 183 A1, and commercial stainless-steel bronzes, and also nonmetallic effect pigments, such as pearlescent pigments and interference pigments, platelet-shaped effect pigments based on iron oxide, having a shade ranging from pink to brownish red, or liquid-crystalline effect pigments, for example. For further details, reference is made to Römpp Lexikon Lacke und Druckfarben, Georg Thieme Verlag, 1998, page 176, “Effect pigments” and pages 380 and 381, “Metal oxide-mica pigments” to “Metal pigments”, and to the patent applications and patents DE 36 36 156 A1, DE 37 18 446 A1, DE 37 19 804 A1, DE 39 30 601 A1, EP 0 068 311 A1, EP 0 264 843 A1, EP 0 265 820 A1, EP 0 283 852 A1, EP 0 293 746 A1, EP 0 417 567 A1, U.S. Pat. No. 4,828,826 A or U.S. Pat. No. 5,244,649 A.

Examples of suitable inorganic color pigments are white pigments such as titanium dioxide, zinc white, zinc sulfide or lithopones; black pigments such as carbon black, iron-manganese black or spinel black; chromatic pigments such as chromium oxide, chromium oxide hydrate green, cobalt green or ultramarine green, cobalt blue, ultramarine blue or manganese blue, ultramarine violet or cobalt violet and manganese violet, red iron oxide, cadmium sulfoselenide, molybdate red or ultramarine red; brown iron oxide, mixed brown, spinel phases and corundum phases or chrome orange; or yellow iron oxide, nickel titanium yellow, chrome titanium yellow, cadmium sulfide, cadmium zinc sulfide, chrome yellow or bismuth vanadate.

Examples of suitable organic color pigments are monoazo pigments, disazo pigments, anthraquinone pigments, benzimidazole pigments, quinacridone pigments, quinophthalone pigments, diketopyrrolopyrrole pigments, dioxazine pigments, indanthrone pigments, isoindoline pigments, isoindolinone pigments, azomethine pigments, thioindigo pigments, metal complex pigments, perinone pigments, perylene pigments, phthalocyanine pigments, or aniline black.

For further details, reference is made to Römpp Lexikon Lacke und Druckfarben, Georg Thieme Verlag, 1998, pages 180 and 181, “Iron blue pigments” to “Black iron oxide”, pages 451 to 453, “Pigments” to “Pigment volume concentration”, page 563, “Thioindigo pigments”, page 567, “Titanium dioxide pigments”, pages 400 and 467, “Naturally occurring pigments”, page 459, “Polycyclic pigments”, page 52, “Azomethine pigments”, “Azo pigments”, and page 379, “Metal complex pigments”.

Examples of fluorescent pigments (daylight fluorescent pigments) are bis(azomethine) pigments.

Examples of suitable electrically conductive pigments are titanium dioxide/tin oxide pigments.

Examples of suitable magnetically shielding pigments are pigments based on iron oxides or chromium dioxide.

Suitable soluble organic dyes are lightfast organic dyes with little or no tendency to migrate from the surfacers and the basecoat materials or from the coatings produced from them. The migration tendency may be estimated by the skilled worker on the basis of his or her general knowledge in the art and/or determined with the aid of simple preliminary rangefinding tests: as part of tinting tests, for example.

Examples of suitable organic and inorganic fillers are chalk, calcium sulfates, barium sulfate, silicates such as talc, mica or kaolin, silicas, oxides such as aluminum hydroxide or magnesium hydroxide, or organic fillers such as polymer powders, especially those of polyamide or polyacrylonitrile. For further details, reference is made to Römpp Lexikon Lacke und Druckfarben, Georg Thieme Verlag, 1998, pages 250 ff., “Fillers”.

It is advantageous to use mixtures of platelet-shaped inorganic fillers such as talc or mica and nonplatelet-shaped inorganic fillers such as chalk, dolomite, calcium sulfates or barium sulfate, since by this means it is possible to adjust the viscosity and the rheology very effectively.

The above-described pigments, dyes and fillers may also be present in the clearcoat materials, in a finely divided, nonhiding form.

Additives such as nanoparticles, reactive diluents curable thermally or with actinic radiation, low-boiling organic solvents and high-boiling organic solvents (“long solvents”), water, UV absorbers, light stabilizers, free-radical scavengers, thermally labile free-radical initiators, photoinitiators and photocoinitiators, crosslinking agents, thermal crosslinking catalysts, devolatilizers, slip additives, polymerization inhibitors, defoamers, emulsifiers, wetting agents, dispersants, adhesion promoters, leveling agents, film-forming auxiliaries, sag control agents (SCAs), rheology control additives (thickeners), flame retardants, siccatives, dryers, antiskinning agents, corrosion inhibitors, waxes, flatting agents and/or precursors of organically modified ceramic materials may be present both in the surfacers and basecoat materials and in the clearcoat materials.

Suitable nanoparticles are, in particular, those based on silica, alumina and zirconium oxide with a particle size <50 nm which have no flatting effect. Examples of suitable nanoparticles based on silica are pyrogenic silicas, which are sold under the trade name Aerosil® VP8200, VP721 or R972 by Degussa, or under the trade names Cab 0 Sil® TS 610, CT 1110F or CT 1110G by Cabot. Generally, these nanoparticles are sold in the form of dispersions in monomers curable with actinic radiation, such as the reactive diluents described below. Examples of suitable monomers which are especially appropriate for the present intended use are alkoxylated pentaerythritol tetraacrylate or tri-acrylate, ditrimethylolpropane tetraacrylate or tri-acrylate, dineopentyl glycol diacrylate, trimethylolpropane triacrylate, trishydroxyethyl isocyanurate triacrylate, dipentaerythritol pentaacrylate or hexaacrylate, or hexanediol diacrylate. In general, these dispersions contain the nanoparticles in an amount, based in each case on the dispersion, of from 10 to 80% by weight, preferably from 15 to 70% by weight, with particular preference from 20 to 60% by weight, and in particular from 25 to 50% by weight. One example of a nanoparticle dispersion especially suitable in accordance with the invention is the dispersion sold by Clariant Hoechst under the trade name High Link® OG 103-31.

These dispersions of nanoparticles are used with preference in the clearcoat materials for use in accordance with the invention since they make it possible to establish a solids content of up to 100% in the clearcoat materials and because the clearcoat materials in question provide particularly scratch-resistant clearcoats.

Examples of suitable thermally curable reactive diluents are positionally isomeric diethyloctanediols or hydroxyl-containing hyperbranched compounds or dendrimers, as described, for example, in the German patent applications DE 198 05 421 A1, DE 198 09 643 A1 or DE 198 40 405 A1.

Examples of suitable reactive diluents curable with actinic radiation are those described in Römpp Lexikon Lacke und Druckfarben, Georg Thieme Verlag, Stuttgart, N.Y. , 1998, on page 491 under the heading “Reactive diluents”, or in column 7 lines 1 to 26 of DE 198 18 715 A1, or reactive diluents whose molecule contains at least 5, especially 5, bonds which can be activated with actinic radiation, such as dipentaerythritol pentaacrylate, for example.

Examples of suitable low-boiling organic solvents and high-boiling organic solvents (“long solvents”) are ketones such as methyl ethyl ketone, methyl isoamyl ketone or methyl isobutyl ketone, esters such as ethyl acetate, butyl acetate, ethyl ethoxypropionate, methoxypropyl acetate or butyl glycol acetate, ethers such as dibutyl ether or ethylene, diethylene, propylene, dipropylene, butylene or dibutylene glycol dimethyl, diethyl or dibutyl ether, N-methylpyrrolidone or xylenes, or mixtures of aromatic and/or aliphatic hydrocarbons such as Solventnaphtha®, petroleum spirit 135/180, dipentenes, or Solvesso®.

Examples of suitable thermally labile free-radical initiators are organic peroxides, organic azo compounds or C-C-cleaving initiators such as dialkyl peroxides, peroxocarboxylic acids, peroxodicarbonates, peroxide esters, hydroperoxides, ketone peroxides, azo dinitriles or benzpinacol silyl ethers.

Examples of suitable crosslinking catalysts are dibutyltin dilaurate, dibutyltin dioleate, lithium decanoate, zinc octoate or bismuth salts such as bismuth lactate or bismuth dimethylolpropionate.

Examples of suitable photoinitiators and coinitiators are described in Römpp Lexikon Lacke und Druckfarben, Georg Thieme Verlag, Stuttgart, 1998, pages 444 to 446.

Examples of suitable crosslinking agents as used in multicomponent systems are polyisocyanates containing on average per molecule at least 2.0, preferably more than 2.0, and in particular more than 3.0 isocyanate groups, such as

diisocyanates such as isophorone diisocyanate (i.e. 5-isocyanato-1-isocyanatomethyl-1,3,3-tri-methylcyclohexane), 5-isocyanato-1-(2-isocyanatoeth-1-yl)-1,3,3-trimethylcyclohexane, 5-iso-cyanato-1-(3-isocyanatoprop-1-yl)-1,3,3-trimethyl-cyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane, 1,2-diisocyanatocyclobutane, 1,3-diisocyanatocyclobutane, 1,2-diisocyanatocyclopentane, 1,3-diisocyanatocyclopentane, 1,2-diisocyanatocyclohexane, 1,3-diisocyanatocyclohexane, 1,4-diisocyanatocyclohexane, dicyclohexylmethane 2,4′-diisocyanate, trimethylene diisocyanate, tetramethylene diisocyanate, pentamethylene diisocyanate, hexamethylene diisocyanate (HDI), ethylethylene diisocyanate, trimethylhexane diisocyanate, heptamethylene diisocyanate or diisocyanates derived from dimeric fatty acids, as sold by Henkel under the commercial designation DDI 1410 and described in the patents WO 97/49745 and WO 97/49747, especially 2-heptyl-3,4-bis(9-isocyanatononyl)-1-pentylcyclohexane, or 1,2-, 1,4- or 1,3-bis-(isocyanatomethyl)cyclohexane, 1,2-, 1,4- or 1,3-bis(2-isocyanatoeth-1-yl)cyclohexane, 1,3-bis-(3-isocyanatoprop-1-yl)cyclohexane, 1,2-, 1,4- or 1,3-bis(4-isocyanatobut-1-yl)cyclohexane, or liquid bis(4-isocyanatocyclohexyl)methane with a trans/trans content of up to 30% by weight, preferably 25% by weight, and in particular 20% by weight, as described in the patent applications DE 44 14 032 A1, GB 1220717 A1, DE 16 18 795 A1 or DE 17 93 785 A1, preferably isophorone diisocyanate, 5-isocyanato-1-(2-isocyanatoeth-1-yl)-1,3,3-trimethylcyclohexane, 5-isocyanato-1-(3-isocyanatoprop-1-yl)-1,3,3-trimethylcyclohexane, 5-isocyanato-(4-isocyanatobut-1-yl)-1,3,3-trimethylcyclohexane, 1-isocyanato-2-(3-isocyanatoprop-1-yl)cyclohexane, 1-isocyanato-2-(3-isocyanatoeth-1-yl)cyclohexane, 1-isocyanato-2-(4-isocyanatobut-1-yl)cyclohexane or HDI, especially HDI; or

polyisocyanates containing isocyanurate, biuret, allophanate, iminooxadiazinedione, urethane, urea, carbodiimide and/or uretdione groups, these polyisocyanates being prepared in customary and known manner from the diisocyanates described above. Examples of suitable preparation processes and polyisocyanates are known, for example, from the patents CA 2,163,591 A, U.S. Pat. No. 4,419,513 A, U.S. Pat. No. 4,454,317 A, EP 0 646 608 A, U.S. Pat. No. 4,801,675 A, EP 0 183 976 A1, DE 40 15 155 A1, EP 0 303 150 A1, EP 0 496 208 A1, EP 0 524 500 A1, EP 0 566 037 A1, U.S. Pat. No. 5,258,482 A, U.S. Pat. No. 5,290,902 A, EP 0 649 806 A1, DE 42 29 183 A1 and EP 0 531 820 A1.

Examples of suitable crosslinking agents as used in one-component systems are amino resins, as described for example in Römpp Lexikon Lacke und Druckfarben, Georg Thieme Verlag, 1998, page 29, “Amino resins”, in the textbook “Lackadditive” [Additives for coatings] by Johan Bieleman, Wiley-VCH, Weinheim, N.Y., 1998, pages 242 ff., in the book “Paints, Coatings and Solvents”, second, completely revised edition, D. Stoye and W. Freitag (Eds.), Wiley-VCH, Weinheim, N.Y., 1998, pages 80 ff., in the patents U.S. Pat. No. 4,710,542 A or EP 0 245 700 A1, and in the article by B. Singh and coworkers, “Carbamylmethylated Melamines, Novel Crosslinkers for the Coatings Industry”, in Advanced Organic Coatings Science and Technology Series, 1991, volume 13, pages 193 to 207, carboxyl-containing compounds or resins, as described for example in the patent DE 196 52 813 A1, resins or compounds containing epoxide groups, as described for example in the patents EP 0 299 420 A1, DE 22 14 650 B1, DE 27 49 576 B1, U.S. Pat. No. 4,091,048 A or U.S. Pat. No. 3,781,379 A, blocked polyisocyanates, as described for example in the patents U.S. Pat. No. 4,444,954 A, DE 196 17 086 A1, DE 196 31 269 A1, EP 0 004 571 A1 or EP 0 582 051 A1, and/or tris(alkoxycarbonylamino)triazines, as described in the patents U.S. Pat. No. 4,939,213 A, U.S. Pat. No. 5,084,541 A, U.S. Pat. No. 5,288,865 A or EP 0 604 922 A1.

Examples of suitable devolatilizers are diazadicycloundecane and benzoin.

Examples of suitable emulsifiers are nonionic emulsifiers, such as alkoxylated alkanols, polyols, phenols and alkylphenols, or anionic emulsifiers such as alkali metal salts or ammonium salts of alkane carboxylic acids, alkanesulfonic acids and sulfo acids of alkoxylated alkanols, polyols, phenols and alkylphenols.

Examples of suitable wetting agents are siloxanes, fluorine compounds, carboxylic monoesters, phosphoric esters, polyacrylic acids and their copolymers, or polyurethanes.

An example of a suitable adhesion promoter is tricyclodecanedimethanol.

Examples of suitable film-forming auxiliaries are cellulose derivatives such as cellulose acetobutyrate (CAB).

Examples of suitable sag control agents are ureas, modified ureas and/or silicas, as described, for example, in the literature references EP 0 192 304 A1, DE 23 59 923 A1, DE 18 05 693 A1, WO 94/22968, DE 27 51 761 C1, WO 97/12945 or “farbe+lack”, 11/1992, pages 829 ff.

Examples of suitable rheology control additives (thickeners) are those known from the patent applications WO 94/22968, EP 0 276 501 A1, EP 0 249 201 A1 or WO 97/12945; crosslinked polymeric microparticles, as disclosed, for example, in EP 0 008 127 A1; inorganic phyllosilicates such as aluminum-magnesium silicates, sodium-magnesium and sodium-magnesium-fluorine-lithium phyllosilicates of the montmorillonite type; silicas such as Aerosils; or synthetic polymers containing ionic and/or associative groups, such as polyvinyl alcohol, poly(meth)acrylamide, poly(meth)acrylic acid, polyvinylpyrrolidone, styrene-maleic anhydride or ethylenemaleic anhydride copolymers and their derivatives, or polyacrylates; or associative thickeners based on polyurethane, as described in Römpp Lexikon Lacke und Druckfarben, Georg Thieme Verlag, Stuttgart, N.Y., 1998, “Thickeners”, pages 599 to 600, and in the textbook “Lackadditive” by Johan Bieleman, Wiley-VCH, Weinheim, N.Y., 1998, pages 51 to 59 and 65; especially combinations of ionic and nonionic thickeners, as described in the patent application DE 198 41 842 A1 for producing pseudoplasticity; or the combination of associative thickeners based on polyurethane and wetting agents based on polyurethane, as described in the German patent application DE 198 35 296 A1 in detail.

An example of a suitable flatting agent is magnesium stearate.

Examples of suitable precursors of organically modified ceramic materials are hydrolyzable organometallic compounds, especially those of silicon and aluminum.

Further examples of the above-mentioned additives and also examples of suitable UV absorbers, free-radical scavengers, leveling agents, flame retardants, siccatives, dryers, antiskinning agents, corrosion inhibitors and waxes are described in detail in the textbook “Lackadditive” by Johan Bieleman, Wiley-VCH, Weinheim, N.Y., 1998.

In accordance with the invention, in a first step of the process for producing the multicoat system of the invention, at least one, especially one, surfacer is applied to the primed or unprimed substrate.

Suitable in this context are all aqueous or nonaqueous surfacers which may be applied and cured with the aid of the processes described above under the conditions described above.

In a first preferred embodiment, thermally curable surfacers based on aqueous polyurethane dispersions are used.

Examples of suitable thermally curable surfacers based on aqueous polyurethane dispersions are described in the German patent application DE 40 05 961 A1.

They comprise as binders a combination of

from 40 to 70% by weight of a water-dilutable polyurethane resin,

from 15 to 40% by weight of a water-dilutable polyester resin, and

from 8 to 35% by weight of an amino resin,

the percentages by weight being based on the overall amount of the three constituents.

The polyurethane resin has an acid number of from 10 to 60 mg KOH/g and a number-average molecular weight of from 4000 to 25 000. It is preparable by reacting

a polyester- and/or polyetherpolyol having a number-average molecular weight of from 400 to 5000 or a mixture of such polyester- and/or polyetherpolyols,

a polyisocyanate or a mixture of polyisocyanates,

a compound whose molecule contains at least one isocyanate-reactive group and at least one group capable of forming anions, or a mixture of such compounds, and, if desired,

a hydroxyl- and/or amino-containing organic compound having a molecular weight of from 40 to 400 or a mixture of such compounds

with one another and subjecting the resulting reaction product to full or partial neutralization.

The water-dilutable polyester resin has an acid number of from 20 to 100 mg KOH/g and a hydroxyl number of from 40 to 150 mg KOH/g and is preparable by reacting

(i) an organic compound containing at least three functional groups, at least one of the functional groups necessarily being a carboxyl group and the other functional groups possibly being hydroxyl and/or amino and/or carboxyl and/or acid anhydride groups, one acid anhydride group counting as two functional groups, or mixtures of such organic compounds,

(ii) a cyclic dicarboxylic acid or a mixture of cyclic dicarboxylic acids,

(iii) if desired, an aliphatic dicarboxylic acid or a mixture of aliphatic dicarboxylic acids,

(iv) a polyol in which at least one alpha carbon atom is a secondary or tertiary carbon atom or a member of a carbon-containing ring system, or a mixture of such polyols, and

(v) if desired, a polyol other than (iv), or a mixture of such polyols

with one another. The carboxylic acid component [(i)+(ii)+(iii)] and the polyol component [(iv)+(v)] are used in a molar ratio of from 3:4 to 7:8. The molar ratio between [(i)+(ii)] and (iii) is from 50:50 to 100:0. The molar ratio between (iv) and (v) is from 40:60 to 100:0. The resultant reaction product is subjected to full or partial neutralization.

Further examples of suitable aqueous surfacers based on polyurethane dispersions are described in detail in the International patent application Wo 95/12626.

They comprise as binder a water-dilutable polyurethane resin preparable by reacting in a first stage

a diisocyanate or a mixture of diisocyanates and

a compound whose molecule contains at least one isocyanate-reactive group and at least one acidic group capable of forming anions, or a mixture of such compounds,

if desired, a polyester- and/or polyetherpolyol having a number-average molecular weight of from 400 to 5000, or a mixture of such polyester- and/or polyetherpolyols, and

if desired, a polyol having a number-average molecular weight of from 60 to 399 or a mixture of such polyols,

to give an isocyanato-containing prepolymer (I), the components of the first stage being reacted with one another in a ratio such that the ratio of equivalents of the isocyanate groups and the isocyanate-reactive groups is from 1.04:1.0 to 10.0:1.0 and the polyurethane resin prepared from the components of the first stage and also the components of the second stage, described below, has an acid number of from 18 to 70 mg KOH/g.

In a second stage, the isocyanato-containing prepolymer (I) is reacted with

a blocking agent or a mixture of blocking agents, to give a prepolymer (II) containing blocked isocyanate groups. The component is used in an amount such that the prepolymer (II) still contains on average at least one free isocyanate group per molecule (partial blocking).

Further, the prepolymer (II) is mixed with

from 2.0 to 400% by weight, based on the amount of prepolymer (II), of a mixture of polyisocyanates containing on average more than 2.0 isocyanate groups per molecule and free from acidic groups capable of forming anions, and the partially blocked polyisocyanates described above.

The mixture of the prepolymer (II) and the abovementioned component is reacted with

a compound whose molecule contains at least one primary or secondary amino group and at least one hydroxyl group, or a mixture of such compounds,

to give a polyurethane resin. The resultant polyurethane resin is subsequently subjected to full or partial neutralization.

Further examples of suitable aqueous surfacers based on polyurethane dispersions are described in the European patent EP 0 788 523 B1. These are coating formulations free of polyester and amino resin which

comprise as binder a water-dilutable polyurethane resin which has an acid number of from 10 to 60 and a number-average molecular weight of from 4000 to 25 000, preferably from 8000 to 25 000, and is preparable by reacting

a polyester- and/or polyetherpolyol having a number-average molecular weight of from 400 to 5000 or a mixture of such polyester- and/or polyetherpolyols,

a polyisocyanate or a mixture of polyisocyanates,

a compound whose molecule contains at least one isocyanate-reactive group and at least one group capable of forming anions, or a mixture of such compounds, and, if desired,

a hydroxyl- and/or amino-containing organic compound having a molecular weight of from 40 to 400 or a mixture of such compounds with one another, and subjecting the resulting reaction product to at least partial neutralization, and

comprise pigments and/or fillers, the ratio of binder to pigment and/or filler being between 0.5:1 and 1.5:1.

In a second preferred embodiment, nonaqueous multicomponent surfacers are used whose composition is described, for example, in the German patent applications DE 198 45 740 A1 or DE 198 46 971 A1. They comprise

one or more polyester resins having an OH number of from 80 to 200 mg KOH/g and an acid number <10 mg KOH/g,

one or more polyacrylate resins having an OH number of from 80 to 200 mg KOH/g and an acid number <20 mg KOH/g,

one or more diisocyanates and/or polyisocyanates containing free and/or blocked isocyanate groups,

one or more organic solvents.

In a third preferred embodiment, dual-cure surfacers are used, curable thermally and with actinic radiation. An especially suitable multicomponent surfacer is described, for example, in the German patent application DE 199 20 799.2, unpublished at the priority date of the present specification. This surfacer preferably comprises

at least one first constituent containing on average

at least two functional groups which contain at least one bond which can be activated with actinic radiation, and, if desired,

at least one functional group which is able to undergo thermal crosslinking reactions with a complementary functional group in the second constituent per molecule and

at least one second constituent containing on average

at least two functional groups which contain at least one bond which can be activated with actinic radiation, and

at least one functional group which is able to undergo thermal crosslinking reactions with a complementary functional group in the first constituent

per molecule.

The first and second constituents may be compounds of low molecular mass, i.e., reactive diluents; or may be oligomers or polymers.

Examples of suitable complementary functional groups are evident from the overview below, in which R represents organic radicals.

Overview: Examples of complementary functional groups in the

First constituent and second constituent
or
Second constituent and first constituent

| | |
|---|---|
| —SH | —C(O)—OH |
| —NH₂ | —C(O)—O—C(O)— |
| —OH | —NCO |
| >NH | —NH—C(O)—OR |
| —NHR | —CH₂—OH |
| | —CH₂—O—CH₃ |
| | —NH—C(O)—CH(—C(O)OR)₂ |
| | —NH—C(O)—CH(—C(O)OR)(—C(O)—R) |
| | —NH—C(O)—NR₂ |
| | ═Si(OR)₂ |
| | 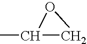 |
| —C(O)—OH | 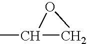 |
| —O—C(O)—CR═CH₂ | —OH |
| —O—CR═CH₂ | —NH₂ |
| | —C(O)—CH₂—C(O)—R |
| | —CH═CH₂ |

Particular advantages result from using isocyanate-reactive functional groups such as hydroxyl, thiol, primary or secondary amino groups or imino groups, especially hydroxyl groups, as functional groups in the first constituent and isocyanate groups as functional groups in the second constituent.

The polymers or oligomers used as first binders normally have a number-average molecular weight of from 500 to 50 000, preferably from 1000 to 5000. They preferably have a double bond equivalent weight of from 400 to 2000, with particular preference from 500 to 900. Moreover, at 23° C., they preferably have a viscosity of from 250 to 11 000 mPas. They are employed preferably in an amount of from 5 to 90% by weight, with particular preference from 10 to 80% by weight, and in particular from 15 to 70% by weight, based in each case on the overall amount of the surfacer.

Examples of suitable first binders or of resins come from the oligomer and/or polymer classes of the (meth)acryloyl-functional (meth)acrylic copolymers, polyether acrylates, polyester acrylates, polyesters, epoxy acrylates, urethane acrylates, amino acrylates, melamine acrylates, silicone acrylates and phosphazene acrylates and the corresponding methacrylates. It is preferred to use first binders which are free from aromatic structural units. Preference is therefore given to the use of urethane (meth)acrylates, phosphazene (meth)acrylates and/or polyester (meth)acrylates, with particular preference urethane (meth)acrylates, especially aliphatic urethane (meth)acrylates.

The urethane (meth)acrylates are obtained by reacting a diisocyanate or polyisocyanate with a chain extender from the group of the diols/polyols and/or diamines/polyamines and/or dithiols/polythiols and/or alkanolamines and subsequently reacting the remaining free isocyanate groups with at least one hydroxyalkyl (meth)acrylate or hydroxyalkyl ester of other ethylenically unsaturated carboxylic acids.

The amounts of chain extender, di- and/or polyisocyanate and hydroxyalkyl ester are in this case preferably chosen so that

the ratio of equivalents of the NCO groups to the reactive groups of the chain extender (hydroxyl, amino and/or thiol groups) is between 3:1 and 1:2, preferably 2:1, and

the OH groups of the hydroxyalkyl esters of the ethylenically unsaturated carboxylic acids are present in stoichiometric amount in relation to the remaining free isocyanate groups of the prepolymer formed from isocyanate and chain extender.

It is also possible to prepare the urethane (meth)acrylates by first reacting some of the isocyanate groups of a diisocyanate or polyisocyanate with at least one hydroxyalkyl ester and then reacting the remaining isocyanate groups with a chain extender. In this case as well, the amounts of chain extender, isocyanate and hydroxyalkyl ester are chosen so that the ratio of equivalents of the NCO groups to the reactive groups of the chain extender is between 3:1 and 1:2, preferably 2:1, and the ratio of equivalents of the remaining NCO groups to the OH groups of the hydroxyalkyl ester is 1:1. Of course, all intermediate forms between these two processes are also possible. For example, some of the isocyanate groups of a diisocyanate may first be reacted with a diol, after which a further portion of the isocyanate groups may be reacted with the hydroxyalkyl ester, and, subsequently, the remaining isocyanate groups may be reacted with a diamine.

Flexibilization of the urethane (meth)acrylates is possible, for example, by reacting corresponding isocyanate-functional prepolymers or oligomers with relatively long-chain aliphatic diols and/or diamines, especially aliphatic diols and/or diamines having at least 6 carbon atoms. This flexibilization reaction may be carried out before or after the addition of acrylic or methacrylic acid onto the oligomers or prepolymers.

Examples of suitable urethane (meth)acrylates are also the following, commercially available, polyfunctional aliphatic urethane acrylates:

Crodamer® UVU 300 from Croda Resins Ltd., Kent, UK;

Genomer® 4302, 4235, 4297 or 4316 from Rahn Chemie, Switzerland;

Ebecryl® 284, 294, IRR351, 5129 or 1290 from UCB, Drogenbos, Belgium;

Roskydal® LS 2989 or LS 2545 or V94-504 from Bayer AG, Germany;

Viaktin® VTE 6160 from Vianova, Austria; or

Laromer® 8861 from BASF AG, and experiment products derived therefrom by modification.

Hydroxyl-containing urethane (meth)acrylates are known, for example, from the patents U.S. Pat. No. 4,634,602 A or U.S. Pat. No. 4,424,252 A.

An example of a suitable polyphosphazene (meth)acrylate is the phosphazene dimethacrylate from Idemitsu, Japan.

The second constituent also comprises a resin as defined above for the description of the first resins. Accordingly, the second resins also come from the oligomer and polymer classes described above. Of advantage in this context are the (meth)acryloyl-functional (meth)acrylic copolymers, which are therefore used with preference in accordance with the invention as second resins.

The second resins contain at least two, in particular at least three, of the above-described functional groups used for crosslinking with actinic radiation.

The second resins further contain at least one, preferably at least two, and in particular at least three functional groups which serve for thermal crosslinking. Examples of suitable functional groups of this kind may be taken from the overview given above. Isocyanate groups are particularly advantageous in this context and are therefore used with very particular preference in accordance with the invention as functional groups. Particular advantages result if the second resins have an isocyanate group content of from 7 to 20% by weight, with particular preference from 8 to 18% by weight, and in particular from 9 to 16% by weight, based in each case on the second resin.

Examples of suitable second resins of the type described above are described, for example, in the patents U.S. Pat. No. 5,234,970 A, EP 0 549 116 A1 or EP 0 618 244 A1.

The second resins are preferably applied in an amount of from 5 to 90% by weight, with particular preference from 10 to 80% by weight, and in particular from 15 to 70% by weight, based in each case on the overall amount of the multicomponent surfacer.

Following the application of the surfacer, the wet film is dried without being completely cured. This means that the wet film is cured only partially if at all. Drying results in a surfacer film. Alternatively, as described above, the resultant wet film may be cured to give the finished surfacer coat.

The particular variant to which preference is given depends on the requirements of the individual case.

In a further step of the process of the invention for producing the multicoat system of the invention, at least one—especially one—basecoat material is applied to the surfacer film or the surfacer coat to give a wet film.

Suitable basecoat materials are basically all color and/or effect basecoat materials which may be applied and cured in the manner described above. Preferred basecoat materials used are aqueous basecoat materials based on aqueous polyurethane dispersions and/or polyacrylate dispersions.

Suitable examples are the aqueous basecoat materials based on aqueous polyurethane dispersions as are described in the German patent application DE 199 48 821 A1. They comprise a polyurethane with a number-average molecular weight Mn of from 3000 to 50 000 and an acid number of from 10 to 35, said polyurethane being producible by reacting

at least one polyesterpolyol having a number-average molecular weight Mn of from 1000 to 4000, preferably from 1200 to 3000, an acid number of from 0 to 15, preferably from 0 to 10, and an OH number of from 35 to 150, preferably from 50 to 120, based on acyclic aliphatic and cycloaliphatic dicarboxylic acids,

a mixture of at least one diol and one triol,

at least one compound containing at least two isocyanate-reactive functional groups and at least one functional group capable of forming anions, and

a mixture of at least one acyclic aliphatic and at least one cycloaliphatic diisocyanate

with the provisos that

(i) the diols and the triols are present in the mixture in a molar ratio of from 2:1 to 13:1, preferably from 2.5:1 to 8:1,

(ii) the molar ratio of the polyesterpolyols to the mixture is from 4.5:1 to 1:1, preferably from 3.5:1 to 1.5:1, and

(iii) the acyclic aliphatic and cycloaliphatic diisocyanates are present in the diisocyanate mixture in a molar ratio of from 1:0.16 to 1:6, preferably from 1:0.5 to 1:5.5;

to give an isocyanato-containing prepolymer, after which the prepolymer is chain-extended with a polyfunctional amine or amino alcohol and, if desired, is neutralized.

Further examples of suitable aqueous basecoat materials based on polyurethane dispersions are disclosed in the German patent application DE 41 10 520 A1 or in the European patent 0 752 455 B1.

Also suitable, for example, are the aqueous basecoat materials based on aqueous polyacrylate dispersions as are described, for example, in the German patent application DE 195 47 944 A1. The polyacrylate used therein, based on its overall weight, contains from 30 to 60% by weight of C₁ to C₈ alkyl (meth)acrylate-containing monomers, from 30 to 60% by weight of vinylaromatic monomers and from 0.5 to 10% by weight of (meth)acrylic acid. The dispersion further comprises a Theological assistant, which is a synthetic polymer containing ionic and/or associative groups.

The wet basecoat film is either dried without curing it completely, to give a basecoat film, or is cured alone or together with the surfacer film, as described above, to give the basecoat. Preferably, the wet film is dried.

In a third step of the process of the invention for preparing the multicoat system of the invention, at least one—especially one—multicomponent clearcoat material curable thermally and with actinic radiation (dual-cure clearcoat material) is applied to the basecoat film or the basecoat. Preferably, the dual-cure clearcoat material is applied to the basecoat film.

The dual-cure clearcoat material may be an aqueous or a conventional clearcoat material and comprises at least

(A) one component comprising

(A1) at least one constituent containing at least two isocyanate-reactive functional groups and

(A2) at least one constituent containing at least one functional group which contains at least one bond which can be activated with actinic radiation, and/or

(A3) at least one constituent containing at least one isocyanate-reactive functional group and at least one functional group which contains at least one bond which can be activated with actinic radiation; and

(B) one component comprising

(B1) at least one polyisocyanate and/or

(B2) at least one compound containing at least one isocyanate group and at least one functional group which contains at least one bond which can be activated with actinic radiation.

Examples of suitable isocyanate-reactive functional groups are those described above.

Component (A) comprises at least one constituent curable by means of heat alone (A1) containing on average at least two, in particular at least three isocyanate-reactive functional groups in the molecule.

The constituent may be of low molecular mass, oligomeric or polymeric. It is preferably oligomeric or polymeric.

The basic structures of the low molecular mass constituents (A1) are not critical but instead may derive from any of a very wide variety of classes of organic compound. Examples of suitable classes of compound are alkyl, cycloalkyl, alkylcycloalkyl, cycloalkylalkyl, aryl, alkylaryl, cycloalkylaryl, arylalkyl and/or arylcycloalkyl compounds with or without heteroatoms such as oxygen, nitrogen, sulfur, silicon or phosphorus and optionally carrying further substituents which, however, during the preparation of the constituents, their storage and/or their use must not react with the bonds which can be activated with actinic radiation. Examples of suitable low molecular mass constituents (A1) are the reactive diluents described above for thermal curing. %

The basic structures of the oligomeric or polymeric constituents (A1) are likewise not critical and may derive from any of a wide variety of classes of oligomer and polymer. Examples of suitable classes of oligomer and polymer are random, alternating and/or block, linear and/or branched and/or comb addition (co)polymers of ethylenically unsaturated monomers, or polyaddition resins and/or polycondensation resins. Regarding these terms, reference is made to Römpp Lexikon Lacke und Druckfarben, Georg Thieme Verlag, Stuttgart, N.Y., 1998, page 457, “Polyaddition” and “Polyaddition resins (polyadducts)”, and also pages 463 and 464, “Polycondensates”, “Polycondensation” and “Polycondensation resins”. Regarding any substituents which may be present, the comments made above apply accordingly.

Examples of highly suitable addition (co)polymers (A1) are poly (meth)acrylates and partially saponified polyvinyl esters. In accordance with the invention, the (meth)acrylate copolymers have particular advantages and are therefore used with particular preference.

The (meth)acrylate copolymers (A1) are polymers known per se. Their preparation has no special features in terms of process but instead takes place with the aid of the methods, customary and known in the polymers field, of continuous or batchwise free-radically initiated copolymerization in bulk, solution, emulsion, miniemulsion or microemulsion, under atmospheric pressure or superatmospheric pressure, in stirred vessels, autoclaves, tube reactors, loop reactors or Taylor reactors, at temperatures from 50 to 200° C.

Examples of suitable (meth)acrylate copolymers (A1) and copolymerization methods are described in the patent applications DE 197 09 465 A1, DE 197 09 476 A1, DE 28 48 906 A1, DE 195 24 182 A1, DE 198 28 742 A1, DE 196 28 143 A1, DE 196 28 142 A1, EP 0 554 783 A1, WO 95/27742, WO 82/02387 or WO 98/02466.

Examples of highly suitable polyaddition resins and/or polycondensation resins (A1) are polyesters, alkyds, polyurethanes, polylactones, polycarbonates, polyethers, epoxy resin-amine adducts, polyureas, polyamides and polyimides.

In accordance with the invention, the polyurethanes (A1) have particular advantages and are therefore used with particular preference. Examples of polyurethanes which may be used with advantage in aqueous dual-cure clearcoat materials are known from the German patent applications DE 199 04 330 A1, DE 198 55 125 A1 or 198 55 167 A1.

The amount of the constituents (A1) in the dual-cure clearcoat materials may vary widely. It is preferably from 1 to 60, more preferably from 3 to 55, and in particular from 5 to 50% by weight, based in each case on the solids of the dual-cure clearcoat material.

Component (A) of the dual-cure clearcoat material further comprises at least one constituent (A2) whose molecule contains on average at least one functional group which contains at least one, especially one, bond which can be activated with actinic radiation.

Examples of suitable bonds which can be activated with actinic radiation are carbon-hydrogen single bonds or carbon-carbon, carbon-oxygen, carbon-nitrogen, carbon-phosphorus or carbon-silicon single bonds or double bonds. Of these, the double bonds, especially the carbon-carbon double bonds (“double bonds”), are employed with preference.

Very suitable double bonds are present, for example, in (meth)acrylate, ethacrylate, crotonate, cinnamate, vinyl ether, vinyl ester, ethenylarylene, dicyclopentadienyl, norbornenyl, isoprenyl, iso-propenyl, allyl or butenyl groups; ethenylarylene ether, dicyclopentadienyl ether, norbornenyl ether, isoprenyl ether, isopropenyl ether, allyl ether or butenyl ether groups; or ethenylarylene ester, dicyclopentadienyl ester, norbornenyl ester, isoprenyl ester, isopropenyl ester, allyl ester or butenyl ester groups. Of these, (meth)acrylate groups, especially acrylate groups, are of particular advantage and are therefore used with very particular preference in accordance with the invention.

The double bonds may be present as terminal and/or lateral double bonds in the constituent.

Suitable basic structures are the low molecular mass, oligomeric and polymeric basic structures described above.

Examples of suitable low molecular mass constituents (A2) are the above-described reactive diluents curable with actinic radiation.

Examples of suitable oligomeric and polymeric constituents (A2) are polyurethanes containing terminal and/or lateral double bonds. The preparation of polyurethanes having terminal and/or lateral double bonds has no special features in terms of its method but instead is described in detail in the patent applications and patents DE 196 45 761 A, WO 98/10028, EP 0 742 239 A1, EP 0 661 321 B, EP 0 608 021 B1, EP 0 447 998 B1 or EP 0 462 287 B1.

Also suitable as constituents (A2) are the acrylated methacrylate copolymers described in the European patent application EP 0 659 979 A1.

The amount of the above-described constituent (A2) in the dual-cure clearcoat material may vary widely. It is preferably from 5 to 60, more preferably from 6 to 55, and in particular from 7 to 50% by weight, based in each case on the solids of the dual-cure clearcoat material.

In addition to the above-described constituents (A1) and/or (A2), component (A) of the dual-cure clearcoat material comprises at least one constituent (A3) containing on average per molecule at least one, especially two, isocyanate-reactive functional groups and at least one, especially two, functional groups containing at least one, especially one, bond which can be activated with actinic radiation.

Suitable isocyanate-reactive functional groups and suitable functional groups which can be activated with actinic radiation are those described above. Furthermore, the above-described basic structures are suitable for the construction of the constituents (A3). Examples of suitable constituents (A3) are known from the patent applications and patents EP 0 522 420 A1, EP 0 522 419 A1, U.S. Pat. No. 4,634,602 A or U.S. Pat. No. 4,424,252 A or DE 198 18 735 A1.

The preparation of component (A) has no special features in terms of its method but instead takes place with the aid of the customary and known mixing techniques and equipment such as stirred vessels, dissolvers, Ultraturrax or extruders.

The amount of the above-described constituent (A3) in the dual-cure clearcoat material may vary widely. It is preferably from 5 to 60, more preferably from 6 to 55, and in particular from 7 to 50% by weight, based in each case on the solids of the dual-cure clearcoat material.

Component (B) of the dual-cure clearcoat material comprises at least one polyisocyanate (B1) Examples of suitable polyisocyanates (B1) are those described above.

Instead of the polyisocyanates (B1) or in addition to them, component (B) comprises at least one compound (B2) containing at least one isocyanate group and at least one functional group containing at least one bond which can be activated with actinic radiation. As is known, these compounds (B2) are obtainable by the reaction of the above-described diisocyanates and polyisocyanates with compounds containing at least one, especially one, of the above-described isocyanate-reactive functional groups and at least one, especially one, bond which can be activated with actinic radiation. Examples of suitable compounds of this kind are

2-hydroxyethyl, 2-hydroxypropyl, 3-hydroxypropyl, 3-hydroxybutyl, 4-hydroxybutyl, bis(hydroxymethyl)cyclohexane, neopentyl glycol, diethylene glycol, dipropylene glycol, dibutylene glycol, triethylene glycol acrylate, methacrylate, ethacrylate, crotonate, cinnamate, vinyl ether, allyl ether, dicyclopentadienyl ether, norbornenyl ether, isoprenyl ether, isopropenyl ether or butenyl ether;

trimethylolpropane di-, glycerol di-, trimethylolethane di-, pentaerythritol tri- or homopenta-erythritol tri-acrylate, -methacrylate, -ethacrylate, -crotonate, -cinnamate, -vinyl ether, -allyl ether, -dicyclopentadienyl ether, -norbornenyl ether, -isoprenyl ether, -isopropenyl ether or -butenyl ether; or

reaction products of cyclic esters, such as epsilon-caprolactone, for example, and the hydroxyl-containing monomers described above; or

2-aminoethyl (meth)acrylate and/or 3-aminopropyl (meth)acrylate.

Viewed in terms of method, the preparation of these compounds (B2) has no special features but instead takes place as described, for example, in the European patent application EP 0 928 800 A1.

Where used, the amount of the compounds (B2) may vary widely. The amount is preferably from 5 to 60, more preferably from 6 to 55 and in particular from 7 to 50% by weight, based in each case on the solids of the dual-cure clearcoat material.

The preparation of component (B) also has no special features in terms of its method but instead takes place by the mixing of its constituents. In order to establish a low viscosity, component (B) may further be admixed with at least one of the above-described organic solvents.

Where the dual-cure clearcoat material includes only components (A) and (B), it comprises a two-component system. However, different constituents of the individual components (A) and/or (B) may be stored separately therefrom and combined to form the multicomponent system only a short time before application. In general, the two-component system is preferred because it is easier to prepare.

Examples of suitable aqueous dual-cure clearcoat materials for use in accordance with the invention are known from the German patent applications DE 198 55 167 A1 and DE 198 55 146 A1.

The preparation of the dual-cure clearcoat materials from the components described above has no special features in terms of its method but instead is carried out with the aid of the customary and known, above-described mixing equipment and mixing techniques or by means of customary two-component or multicomponent metering and mixing units.

Following its application, the dual-cure clearcoat film is cured alone, together with the basecoat film (wet-on-wet technique) or together with the basecoat film or surfacer film (extended wet-on-wet technique) to give the multicoat system of the invention.

The multicoat system of the invention produced in the manner of the invention, despite the low curing temperatures, has the quality required for use in automotive OEM finishing. Accordingly, its optical properties (appearance) such as

gloss,

distinctness of image (DOI),

hiding power,

uniformity in shade at different locations, and

precise dichroic optical effects;

its mechanical properties such as

hardness,

scratch resistance,

abrasion resistance, and

impact resistance;

its adhesion properties such as

intercoat adhesion, and

adhesion to the substrate;

and also its chemical properties such as

weathering stability,

UV resistance,

resistance to blushing,

etch resistance, and

resistance to chemicals (especially acids and bases), solvents, tree resin, bird droppings, and gasoline

are at a sufficiently high level for them to be suitable, inter alia, for finishing particularly high-value, top-class automobiles.

### EXAMPLES

### Preparation Example 1

The Preparation of a Methacrylate Copolymer (A1)

A laboratory reactor with a useful volume of four liters, equipped with a stirrer, two dropping funnels (monomer feed and initiator feed), nitrogen inlet pipe, thermometer, and reflux condenser, was charged with 650 parts by weight of a fraction of aromatic hydrocarbons having a boiling range of from 158 to 172° C. The solvent was heated to 140° C. Thereafter, a monomer mixture comprising 652 parts by weight of ethylhexyl acrylate, 383 parts by weight of hydroxyethyl methacrylate, 143 parts by weight of styrene, 213 parts by weight of 4-hydroxybutyl acrylate and 21 parts by weight of acrylic acid was metered in at a uniform rate over the course of 4 hours, with stirring, and an initiator solution comprising 113 parts by weight of tert-butyl perethylhexanoate and 113 parts by weight of the solvent was metered in at a uniform rate over the course of 4.5 hours with stirring. The metered addition of the monomer mixture and of the initiator solution was commenced simultaneously. After the end of the initiator feed, the resulting reaction mixture was left to continue polymerization at 140° C. for 2 hours, and then cooled. The resultant polymer solution was diluted with a mixture of 1-methoxypropyl 2-acetate, butyl glycol acetate and butyl acetate so that the solids content was 65% by weight (one hour in a forced air oven at 130° C.). The acid number was 15 mg KOH/g solids.

Preparation Example 2

The Preparation of a Dual-Cure Clearcoat Material

To prepare component (A) of the dual-cure clearcoat material, 35.9 parts by weight of the methacrylate copolymer (A1) from Preparation Example 1, 20 parts by weight of dipentaerythritol pentaacrylate, 1.0 part by weight of substituted hydroxyphenyltriazine, 1.0 part by weight of N-methyl-2,2,6,6-tetramethylpiperidinyl ester, 0.4 part by weight of the commercial leveling agent Byk® 306 from Byk Chemie, 27.4 parts by weight of butyl acetate (98/100), 10.8 parts by weight of Solventnaphtha® and a mixture of the commercial photoinitiators Irgacure® 184 (2.0 parts by weight; Ciba Specialty Chemicals), Genocure® MBF (1.0 part by weight; Rahn Chemie) and Lucirin® TPO (0.5 part by weight; BASF AG) were mixed with one another.

As component (B), the isocyanato acrylate Roskydal® UA VPLS 2337 (isocyanate content: 12% by weight) from Bayer Aktiengesellschaft was used.

Components (A) and (B) were mixed with one another in a weight ratio of 100:30. This gave a ready-to-spray dual-cure clearcoat material with a viscosity of 18 seconds in the DIN4 efflux cup. The density was 1.026 g/cm³ and the solids content 62% by weight.

### Example 1

The Production of a Multicoat System of the Invention

To produce the multicoat system of the invention, the prime substrates used were bodywork-steel test panels which had been pretreated with commercially customary zinc phosphate solution and coated with a cathodic, heat-cured electrodeposition coat in a thickness of from 18 to 22 μm.

A commercial aqueous two-component surfacer from BASF Coatings AG, as is commonly used to coat plastics, was applied to the electrodeposition coat and thermally cured at 90° C. for 30 minutes. This gave a surfacer coat having a thermal thickness of from 35 to 40 μm.

A commercial black aqueous basecoat material from BASF Coatings AG, as is commonly used to coat plastics, was applied to the surfacer coat and dried at 80° C. for 15 minutes.

Finally, the dual-cure clearcoat material from Preparation Example 2 was applied pneumatically in one cross-pass using a gravity-feed gun. The resulting clearcoat film was cured together with the basecoat film. Curing was carried out in a staged process, at room temperature for 5 minutes and at 80° C. for 15 minutes, followed by curing with UV radiation (dose: 1500 mJ/cm²) and a final thermal cure at 90° C. for 30 minutes.

The result was a basecoat having a thickness of 15 μm and a clearcoat having a thickness of from 40 to 45 μm.

The multicoat system of the invention had a gloss of 88.4 to DIN 67530 and a micropenetration hardness of 105 N/mm² (universal hardness 25.6 mN, Fischerscope 100 V with diamond pyramid in accordance with Vickers).

The scratch resistance of the multicoat system was determined by the sand test. For this purpose, the film surface was loaded with sand (20 g of quartz silver sand 1.5-2.0 mm). The sand was placed in a beaker (with its base cut off level) which was attached firmly to the test panel. The panel, with the beaker and the sand, was set in shaking movements by means of a motor drive. The movement of the loose sand caused damage to the film surface (100 double strokes in 20 s). Following sand exposure, the test area was cleaned of abraded material, wiped off carefully under a jet of cold water, and then dried using compressed air. The gloss to DIN 67530 was measured before and after damage (measurement direction perpendicular to the direction of scratching):

initial: 88.4

after damage: 74.9.

In addition, the scratch resistance was etermined in accordance with the brush test as well. For this test, the test panels bearing the multicoat system were stored at room temperature for at least 2 weeks before the test was carried out.

The scratch test was assessed with the aid of the BASF brush test described in FIG. 2 on page 28 of the article by P. Betz and A. Bartelt, Progress in Organic Coatings, 22 (1993), pages 27-37, which was modified, however, in respect of the weight used (2000 g instead of the 280 g specified therein), assessment taking place as follows:

In the test, the film surface was damaged using a weighted mesh fabric. The mesh fabric and the film surface were wetted generously with a laundry detergent solution. The test panel was moved backward and forward in reciprocating movements under the mesh fabric by means of a motor drive.

The test element was an eraser (4.5×2.0 cm, broad side perpendicular to the direction of scratching) lined with nylon mesh fabric (No. 11, 31 μm mesh size, Tg 50° C.). The applied weight was 2000 g.

Prior to each test, the mesh fabric was replaced, with the running direction of the fabric meshes parallel to the direction of scratching. Using a pipette, approximately 1 ml of a freshly stirred 0.25% strength solution of Persil was applied in front of the eraser. The rotary speed of the motor was set so that 80 double strokes were performed within a period of 80 s. After the test, the remaining washing liquid was rinsed off with cold tap water and the test panels were blown dry using compressed air. The gloss to DIN 67530 was measured before and after damage (measurement direction perpendicular to the direction of scratching):

initial: 88.4

after damage: 83.7.

The experimental results demonstrate the outstanding optical properties, the high scratch resistance and the high abrasion resistance of the multicoat system.

The adhesion properties of the multicoat system of the invention were determined by means of the high-pressure test. The test was carried out before and after fourteen-day exposure of the test panels under constant condensation conditions. For the test, a cross was scored into the multicoat system. The area of scoring was subjected to a water jet (pressure: 80 bar, water temperature: 50° C.) from a nozzle tip/test panel distance of 12 cm for 30 seconds using an apparatus from Walter, type LTA2, at an apparatus setting of F2. The adhesion was very good both before and after exposure to the constant condensation conditions; no instances of flaking were found.

What is claimed is:

1. A multicoat color and/or effect coating system with the quality of an automotive OEM coating system, which is producible by
1. applying at least one surfacer curable thermally at a temperature <120° C. or curable with actinic radiation and thermally at a temperature <120° C. to a primed or unprimed substrate and
1.1 drying the resultant wet film without completely curing it, to give a surfacer film, or
1.2 curing the resultant wet film thermally at a temperature <120° C. or with actinic radiation and thermally at a temperature <120° C., to give a surfacer coat,
2. applying at least one basecoat material curable thermally at a temperature <120° C. or curable with actinic radiation and thermally at a temperature <120° C. to the surfacer film (1.1) or the surfacer coat (1.2), and
2.1 drying the resultant wet film without completely curing it, to give a basecoat film, or
2.2 curing the resultant wet film alone or together with the surfacer film (1.1) thermally at a temperature <120° C. or with actinic radiation and thermally at a temperature <120° C., to give a color and/or effect basecoat,
3. applying at least one multicomponent clearcoat material curable with actinic radiation and thermally at a temperature of <120° C. to the basecoat film (2.1) or the basecoat (2.2), and curing the resultant wet film
3.1 alone,
3.2 together with the basecoat film (2.1) or
3.3 together with the basecoat film (2.1) and the surfacer film (1.1)
with actinic radiation and thermally at a temperature <120° C., to give the multicoat system.

2. The multicoat system as claimed in claim 1, wherein actinic radiation used comprises electromagnetic radiation and/or corpuscular radiation.

3. The multicoat system as claimed in claim 2, wherein electromagnetic radiation used comprises near infrared, visible light, UV radiation or X-rays and corpuscular radiation used comprises electron beams.

4. The multicoat system as claimed in any of claims 1 to 3, wherein the thermal curing is conducted at a temperature <110° C.

5. The multicoat system as claimed in any of claims 1 to 4, wherein surfacers used comprise
thermally curable surfacers based on aqueous polyurethane dispersions,
thermally curable multicomponent surfacers, or
surfacers curable thermally and with actinic radiation.

6. The multicoat system as claimed in any of claims 1 to 5, wherein basecoat materials used comprise aqueous basecoat materials based on aqueous polyurethane dispersions and/or polyacrylate dispersions.

7. The multicoat system as claimed in any of claims 1 to 6, wherein the multicomponent clearcoat materials curable thermally and with actinic radiation comprise at least
(A) one component comprising
(A1) at least one constituent containing at least two isocyanate-reactive functional groups and
(A2) at least one constituent containing at least one functional group which contains at least one bond which can be activated with actinic radiation, and/or
(A3) at least one constituent containing at least one isocyanate-reactive functional group and at least one functional group which contains at least one bond which can be activated with actinic radiation; and
(B) one component comprising
(B1) at least one polyisocyanate and/or
(B2) at least one compound containing at least one isocyanate group and at least one functional group which contains at least one bond which can be activated with actinic radiation.

8. The multicoat system as claimed in claim 7, herein bonds used which can be activated with actinic radiation comprise carbon-hydrogen single bonds or carbon-carbon, carbon-oxygen, carbon-nitrogen, carbon-phosphorus or carbon-silicon single bonds or double bonds.

9. The multicoat system as claimed in claim 8, wherein carbon-carbon double bonds (“double bonds”) are used.

10. The multicoat system as claimed in claim 9, wherein the double bonds are present in the form of (meth)acrylate, ethacrylate, crotonate, cinnamate, vinyl ether, vinyl ester, ethenylarylene, dicyclopentadienyl, norbornenyl, isoprenyl, isopropenyl, allyl or butenyl groups; ethenylarylene ether, dicyclopentadienyl ether, norbornenyl ether, isoprenyl ether, isopropenyl ether, allyl ether or butenyl ether groups; or ethenylarylene ester, dicyclopentadienyl ester, norbornenyl ester, isoprenyl ester, isopropenyl ester, allyl ester or butenyl ester groups.

11. The multicoat system as claimed in any of claims 7 to 10, wherein the isocyanate-reactive functional groups comprise thiol, primary or secondary amino, imino or hydroxyl groups.

12. The multicoat system as claimed in any of claims 1 to 11, wherein the multicomponent clearcoat material curable with actinic radiation and thermally at a temperature of <120° C. comprises nanoparticles.

13. A process for producing a multicoat color and/or effect coating system with the quality of an automotive OEM coating system as set forth in any of claims 1 to 12 by application of at least one surfacer coat, at least one basecoat and at least one clearcoat to a primed or unprimed substrate and curing of the resultant wet films, which comprises
1. applying at least one surfacer curable thermally at a temperature <120° C. or curable with actinic radiation and thermally at a temperature <120° C. to a primed or unprimed substrate and
1.1 drying the resultant wet film without completely curing it, to give a surfacer film, or
1.2 curing the resultant wet film thermally at a temperature <120° C. or with actinic radiation and thermally at a temperature <120° C., to give a surfacer coat,
2. applying at least one basecoat material curable thermally at a temperature <120° C. or curable with actinic radiation and thermally at a temperature <120° C. to the surfacer film (1.1) or the surfacer coat (1.2), and
2.1 drying the resultant wet film without completely curing it, to give a basecoat film, or
2.2 curing the resultant wet film alone or together with the surfacer film (1.1) thermally at a temperature <120° C. or with actinic radiation and thermally at a temperature <120° C., to give a color and/or effect basecoat,
3. applying at least one multicomponent clearcoat material curable with actinic radiation and thermally at a temperature of <120° C. to the basecoat film (2.1) or the basecoat (2.2), and curing the resultant wet film
3.1 alone,
3.2 together with the basecoat film (2.1) or
3.3 together with the basecoat film (2.1) and the surfacer film (1.1)
with actinic radiation and thermally at a temperature <120° C., to give the clearcoat, the clearcoat and the basecoat, or the clearcoat, the basecoat and the surfacer coat.

14. The use of the multicoat system as claimed in any of claims 1 to 12 or of a multicoat system produced as claimed in claim 13 for automotive OEM finishing, automotive refinish, the coating of furniture, doors, windows or the interior and exterior of constructions, or for industrial coating, including coil coating, container coating, and the coating or impregnation of electrical components.
